(19) United States
(12) Patent Application Publication
(10) Pub. No.: US 2026/0051086 A1
(43) Pub. Date: Feb. 19, 2026

(54) INTERACTION METHOD, NON-TRANSITORY COMPUTER-READABLE STORAGE MEDIUM AND ELECTRONIC DEVICE

(71) Applicant: Beijing Youzhuju Network Technology Co., Ltd., Beijing (CN)

(72) Inventors: Chenglong LI, Beijing (CN); Xiaowei LI, Beijing (CN); Yang YU, Beijing (CN)

(21) Appl. No.: 19/298,057

(22) Filed: Aug. 12, 2025

(30) Foreign Application Priority Data
Aug. 13, 2024 (CN) 202411111776.0

(51) Int. Cl. G06T 11/00

(52) U.S. Cl. CPC G06T 11/00

(57) ABSTRACT

The present disclosure relates to an interaction method, a non-transitory computer-readable storage medium, and an electronic device, the method includes: displaying a target delivery content in response to receiving, during a display process of a text, an image generation instruction associated with delivery content; acquiring a target text corresponding to the image generation instruction from the text in response to determining that display of the target delivery content is completed; generating target feature information of a target object corresponding to the target text according to the target text; and generating a generated image corresponding to the target object according to the target feature information and displaying the generated image.

### CROSS-REFERENCE TO RELATED APPLICATION

This application claims the priority to and benefits of the Chinese Patent Application, No. 202411111776.0, which was filed on Aug. 13, 2024. The aforementioned patent application is hereby incorporated by reference in its entirety.

### TECHNICAL FIELD

The present disclosure relates to a non-transitory computer-readable storage medium and an electronic device.

### BACKGROUND

With the development of the times, more and more users read through electronic reading devices or reading applications. However, during a reading process, a user may reduce its concentration due to problems such as a novel being too long, and the reading experience is not good.

### SUMMARY

The Summary is provided to introduce the concepts in a simplified form, which will be described in detail in the following Detailed Description of Embodiments. This Summary is not intended to identify key features or essential features of the claimed technical solution, nor is it intended to be used to limit the scope of the claimed technical solution.

In a first aspect, the present disclosure provides an interaction method, the method including:
displaying a target delivery content when receiving, during a display process of a text, an image generation instruction associated with delivery content;
acquiring a target text corresponding to the image generation instruction from the text in response to determining that display of the target delivery content is completed;
generating target feature information of a target object corresponding to the target text according to the target text; and
generating a generated image corresponding to the target object according to the target feature information and displaying the generated image.

In a second aspect, the present disclosure provides an interaction apparatus, the apparatus including: a first display module, configured to display a target delivery content when receiving, during a display process of a text, an image generation instruction associated with delivery content;
an acquisition module, configured to acquire a target text corresponding to the image generation instruction from the text in response to determining that display of the target delivery content is completed;
a generation module, configured to generate target feature information of a target object corresponding to the target text according to the target text; and
a processing module, configured to generate a generated image corresponding to the target object according to the target feature information and display the generated image.

In a third aspect, the present disclosure provides a computer-readable medium, on which a computer program is stored, where the computer program, when executed by a processing apparatus, implements the steps of the method according to the first aspect.

In a fourth aspect, the present disclosure provides an electronic device, including:
a storage apparatus, on which a computer program is stored; and
a processing apparatus, configured to execute the computer program in the storage apparatus to implement the steps of the method according to the first aspect.

In a fifth aspect, the present disclosure provides a computer program product, including a computer program, where the computer program, when executed by a processor, implements the steps of the method according to the first aspect.

In the above technical solution, interaction can be performed in a process of text reading, so that the diversity of user interaction in the process of text reading is improved, and the user can watch the delivery content and obtain the generated image in the process of text reading, which is convenient for increasing the pageview of the delivery content and improving the user participation. In addition, in the process of image generation, there is no need for the user to understand and summarize the feature information of the object, and the target feature information can be automatically generated according to the read text, thereby obtaining the generated image, which saving the operations and workload of the user to obtain the generated image. In addition, the matching degree between the generated image and the text can be guaranteed to a certain extent, so as to avoid the problem that it is difficult to obtain the image required by the user due to the description deviation of the feature by the understanding of user, thereby further improving the user interaction experience. In addition, the understanding degree of the user on the text can be increased by combining the generated image, which can effectively improve the reading interest of the user and the viewing interest of the user on the target delivery content and improve the interaction diversity of the user in the reading process.

Other features and advantages of the present disclosure will be described in detail in the following detailed description of embodiments.

### BRIEF DESCRIPTION OF DRAWINGS

The above and other features, advantages and aspects of the embodiments of the present disclosure will become more apparent when taken in conjunction with the drawings and with reference to the following detailed description of embodiments. Throughout the drawings, the same or similar reference numerals refer to the same or similar elements. It should be understood that the drawings are schematic and that parts and elements are not necessarily drawn to scale. In the drawings:

FIG. 1 is a flowchart of an interaction method provided according to an implementation of the present disclosure.

FIG. 2 is a schematic diagram of a text display interface provided according to an implementation of the present disclosure.

FIG. 3 is a schematic diagram of an interaction interface provided according to an implementation of the present disclosure.

FIG. 4 is a schematic diagram of an interaction interface provided according to another implementation of the present disclosure.

FIG. 5 is a schematic diagram of an image display interface provided according to an implementation of the present disclosure.

FIG. 6 is a block diagram of an interaction apparatus provided according to an implementation of the present disclosure.

FIG. 7 is a schematic structural diagram of an electronic device suitable for implementing the embodiments of the present disclosure.

### DETAILED DESCRIPTION

The embodiments of the present disclosure will be described in more detail below with reference to the drawings. Although some embodiments of the present disclosure are shown in the drawings, it should be understood that the present disclosure can be implemented in various forms, and should not be construed as being limited to the embodiments set forth herein. Rather, these embodiments are provided for a more thorough and complete understanding of the present disclosure. It should be understood that the drawings and embodiments of the present disclosure are only for exemplary purposes, and are not intended to limit the protection scope of the present disclosure.

It should be understood that the various steps described in the method implementations of the present disclosure may be performed in different orders and/or in parallel. In addition, the method implementations may include additional steps and/or omit performing the illustrated steps. The scope of the present disclosure is not limited in this respect.

As used herein, the term “include” and its variants are open-ended inclusions, that is, “include but not limited to”. The term “based on” is “based at least in part on”. The term “an embodiment” represents “at least one embodiment”; the term “another embodiment” represents “at least one other embodiment”; the term “some embodiments” represents “at least some embodiments”. Relevant definitions of other terms will be given in the description below.

It should be noted that the concepts such as “first” and “second” mentioned in the present disclosure are only used to distinguish different apparatuses, modules or units, and are not used to limit the order or interdependence of the functions performed by these apparatuses, modules or units.

It should be noted that the modifications of “one” and “a plurality of” mentioned in the present disclosure are illustrative rather than restrictive, and those skilled in the art should understand that unless the context clearly indicates otherwise, they should be understood as “one or more”.

The names of messages or information exchanged between multiple apparatuses in the implementations of the present disclosure are only used for illustrative purposes, and are not used to limit the scope of these messages or information.

It may be understood that before using the technical solution disclosed in the embodiments of the present disclosure, the user should be informed of the type, scope of use, usage scenario, etc. of the personal information involved in the present disclosure in an appropriate manner according to relevant laws and regulations, and the user's authorization should be obtained.

For example, in response to receiving an active request from the user, prompt information is sent to the user to explicitly prompt the user that the operation requested to be performed will require the acquisition and use of the user's personal information. Thus, the user can independently select whether to provide personal information to software or hardware such as an electronic device, an application, a server, or a storage medium that performs the operation of the technical solution of the present disclosure according to the prompt information.

As an optional but non-limiting implementation, the manner of sending the prompt information to the user in response to receiving the active request from the user may be, for example, a pop-up window, and the prompt information may be presented in the pop-up window in the form of text. In addition, the pop-up window may also carry a selection control for the user to select “agree” or “disagree” to provide personal information to the electronic device.

It may be understood that the above process of notifying and obtaining the user's authorization is only illustrative, and does not constitute a limitation on the implementations of the present disclosure. Other manners that meet relevant laws and regulations may also be applied to the implementations of the present disclosure.

At the same time, it may be understood that the data involved in the technical solution (including but not limited to the data itself, the acquisition or use of the data) should comply with the requirements of corresponding laws, regulations and related provisions.

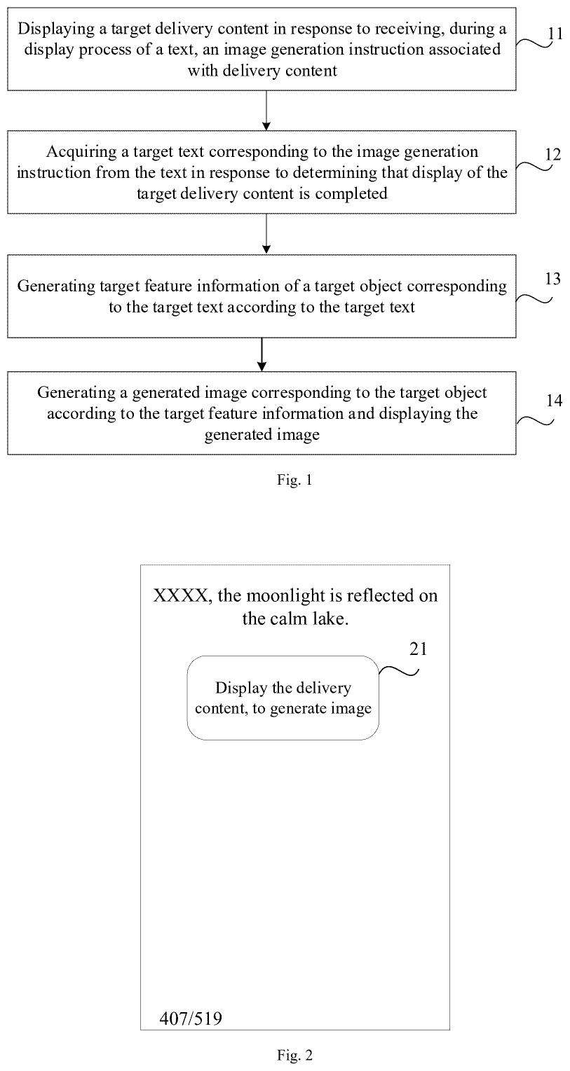

FIG. 1 is a flowchart of an interaction method provided according to an implementation of the present disclosure. As shown in FIG. 1, the method may include the following steps.

In step 11, displaying a target delivery content when receiving, during a display process of a text, an image generation instruction associated with delivery content.

The text may be a text for the user to read, such as a novel or network introduction materials. Taking the text being a novel as an example, when the user reads the text for a long time, the user's attention may be reduced. In this embodiment, the user may be provided with interaction during the displaying process of the text. For example, an interactive identifier may be displayed in a text display interface, and the user can trigger an interactive operation by clicking on the interactive identifier. As another example, a gesture operation for triggering interaction may be preset, and when it is detected that the user inputs the gesture operation in the text display interface, a corresponding interaction may be performed. It may be set according to actual application scenarios, which is not limited in the present disclosure.

As an example, an image generation identifier may be displayed in the text display interface, and the user may trigger image generation by clicking on the image generation identifier. For example, as shown in FIG. 2, the image generation identifier 21 may prompt the user to confirm to display the delivery content, and if the user clicks to confirm, it indicates that the user confirms that the delivery content can be displayed. In this scenario, generation of the image generation instruction associated with the delivery content may be triggered, and then the display of the delivery content may be jumped to, so that the user can browse the delivery content during the process of text reading, thereby increasing the diversity of interaction. The delivery content may be video content, audio content, etc. The image generation identifier may be displayed in the form of a floating identifier in each text display interface, or may be displayed in a text display interface corresponding to the last page of each chapter in the text, so as to improve the continuity of the user's text reading.

In step 12, acquiring a target text corresponding to the image generation instruction from the text in response to determining that display of the target delivery content is completed.

As an example, detection may be performed based on a delivery content display detection manner that is common in the art, for example, it may be determined whether the display duration corresponding to the target delivery content satisfies a target duration, where the target duration may be a total duration of the target delivery content, or may be a duration set according to an actual application scenario, which is not limited in the present disclosure. When determining that the display duration corresponding to the target delivery content satisfies the target duration, it is determined that the display of the target delivery content is completed, and then the target text corresponding to the image generation instruction is acquired to trigger the task of image generation. The target text may be all the text in the text, or may be a part of the text.

In step 13, generating target feature information of a target object corresponding to the target text according to the target text.

As an example, text analysis may be performed based on the target text to determine various objects appearing in the target text, for example, the types of objects may be preset, such as a character role, an animal role, an environment, etc. Then the objects and feature information thereof under the above various types may be determined from the target text.

For example, text processing may be performed on the target text through a natural language processing (NLP) algorithm to extract key information from the target text to generate feature information of the object, such as abstract information, so as to obtain an image description for image generation. For example, when the object is a character role, the target feature information may be information used to describe the character role, such as information about age, personality, appearance, clothes, etc. For example, the algorithm may include, but is not limited to, an information extraction algorithm to identify and extract key information from unstructured text of the target text, such as a person name, an event, an attribute, etc.; a text summarization algorithm to generate a summary based on the target text to obtain a summary of the role description of the object; a sentiment analysis algorithm to determine the emotion and attitude of the object by identifying and processing emotional words in the target text; an entity relationship extraction algorithm to identify and understand the relationship between different entities (such as a person, a place, an event) in the target text. The specific implementations of the above algorithms are common algorithms in the art, and will not be repeated here.

The object with the most corresponding text content in the target text may be used as the target object, or the key object corresponding to the text, such as the protagonist, may be determined based on attribute information of the text, and determined feature information of the protagonist may be used as the target feature information of the target object.

In step 14, generating a generated image corresponding to the target object according to the target feature information and displaying the generated image.

As an example, the target feature may be input into an image generation model to obtain the corresponding generated image. The image generation model may be obtained through pre-training based on a diffusion model, a large language model, etc., and the training manner thereof may be implemented through a general training manner, which is not limited in the present disclosure.

There may be one or more generated images. When there is one generated image, the generated image may be directly displayed in the interaction interface. In the case where there is a plurality of generated images, each generated image may be displayed in the form of an option in the interaction interface, so that the user can select, from the plurality of generated images, the each generated image that meets his needs for downloading or sharing, etc., which is convenient for the user to operate.

Therefore, in the above technical solution, interaction can be performed in the process of text reading, so that the diversity of user interaction in the process of text reading is improved, and the user can watch the delivery content and obtain the generated image in the process of text reading, which is convenient for increasing the pageview of the delivery content and improving the user participation. In addition, in the process of image generation, there is no need for the user to understand and summarize the feature information of the object, and the target feature information can be automatically generated according to the read text, thereby obtaining the generated image, which saving the operations and workload of the user to obtain the generated image. In addition, the matching degree between the generated image and the text can be guaranteed to a certain extent, so as to avoid the problem that it is difficult to obtain the image required by the user due to the description deviation of the feature by the understanding of user, thereby further improving the user interaction experience. In addition, the understanding degree of the user on the text can be increased by combining the generated image, which can effectively improve the reading interest of the user and the viewing interest of the user on the target delivery content, and improve the interaction diversity of the user in the reading process.

In a possible embodiment, the text includes a plurality of chapters, for example, the plurality of chapters in the text may be obtained based on a catalogue corresponding to the text. Correspondingly, the step of acquiring the target text corresponding to the image generation instruction from the text in response to determining that the display of the target delivery content is completed may include:

Determining a current chapter displayed in the text in response to determining the display of the delivery content is completed.

The current chapter may be determined, based on a page corresponding to the currently displayed text in the text. For example, each chapter is associated with a corresponding page range in the text, and a chapter to which the page corresponding to the currently displayed text belongs may be used as the current chapter.

Taking text of the current chapter and text of first N chapters corresponding to the current chapter as the target text, wherein N is an integer greater than or equal to 0, which may be set based on an actual application scenario, and the present disclosure does not limit this.

As an example, the text of the current chapter may be used as the target text, so that the target feature information of the target object may be generated according to the text of the target object in the current chapter, thereby improving the matching degree between the generated image and the text of the currently read chapter. As another example, text of the current chapter and text of consecutive historical chapters thereof may be used as the target text. For example, if the current chapter is an Mth chapter, text of the Mth chapter, an (M−1)th chapter, an (M−2)th chapter to an (M−N)th chapter may be used as the target text, so as to improve the description integrity of the target object in the target text, and provide more comprehensive feature information for image generation. In addition, it may characterize the continuity between a plurality of generated images corresponding to the same object in the process of text reading, thereby improving the accuracy and efficiency of image generation.

In a possible embodiment, the step of generating the target feature information of the target object corresponding to the target text according to the target text may include the following step.

Obtaining candidate objects corresponding to the target text and feature information of the candidate objects based on the target text and a pre-trained text analysis model.

The text analysis model may be the model implemented based on the NLP algorithm as described above to analyze the target text.

As an example, the candidate objects may be preset, for example, for each text, an object that may be subjected to image generation in the text may be preset, such as a protagonist A1, A2, a supporting role B1-Bm, and an environment C1-Cn, which may be pre-configured based on brief information of the text or configuration information about roles. In this embodiment, the target text may be input into the text analysis model, and the text analysis model generates the feature information of each candidate object. It should be noted that if there is no text description for a certain candidate object in the target text, the feature information of the candidate object is empty, for example, the supporting role B1 appears in a 10th chapter, and when the feature information of the candidate object is generated based on the text of a 5th chapter, the feature information of the supporting role B1 is empty.

Then, the selected candidate object is determined as the target object in response to receiving a selection operation of the user on the candidate objects.

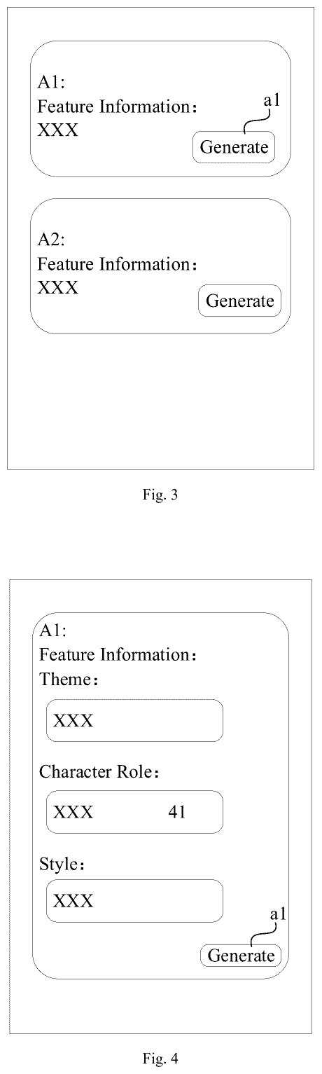

As an example, each candidate object and feature information thereof may be displayed in the interaction interface, respectively, for the user to select and determine the object for which the user wants to perform image generation. The user may select one candidate object by clicking on the candidate object, and the candidate object may be used as the target object. As shown in FIG. 3, the interaction interface may include feature information of characters A1 and A2, and the user may select a1 to achieve the selection of the character A1, and then the character A1 may be used as the target object, and then the generated image corresponding to the character is generated.

Then, the target feature information of the target object is generated according to the feature information of the target object.

As an example, the feature information of the target object may be directly used as the target feature information to perform image generation. As another example, the generated feature information may not be in line with the user's understanding and configuration of the role. In the embodiment of the present disclosure, the feature information of the target object may be displayed, and the user may edit the feature information to obtain the target feature information that meets his intentions and understanding. Therefore, through the above technical solution, the feature information of the respective candidate objects in the target text may be automatically generated according to the target text, without manual summarization by the user, thereby greatly reducing the workload of manual extraction and generation and saving the user's operations. In addition, more candidate objects that may be subjected to image generation may be displayed for the user, so that more comprehensive recommendation is provided for the user, thereby effectively reducing the understanding cost of the user in the process of image generation interaction and improving the efficiency of image generation.

In a possible embodiment, the step of generating the target feature information of the target object according to the feature information of the target object includes the following step.

The feature information of the target object is displayed. As an example, the feature information may be displayed in a same editing region. As another example, the feature information may include information under a plurality of feature dimensions, where the plurality of feature dimensions may be preset, such as a theme dimension, a role dimension, a style dimension, etc., so as to improve the comprehensiveness and structured representation of feature extraction and provide more accurate and effective data support for subsequent image generation. In this example scenario, the information of the target object under the plurality of feature dimensions may be displayed separately. As shown in FIG. 4, the user can more directly understand the feature information of the target object, which is convenient for the user to quickly determine whether the displayed feature information meets his needs and intentions for image generation.

Accordingly, the step of generating the target feature information of the target object according to the feature information of the target object may include the following step.

In response to receiving an edit operation of the user for the feature information, the feature information obtained after editing is determined as the target feature information. As an example, if the user considers that the currently displayed feature information does not meet his requirements, the user may perform editing in the editing region. When the feature information is displayed under a plurality of feature dimensions separately, if the user considers that the information under a certain displayed feature dimension does not meet his needs, the user may edit it, for example, some descriptions may be deleted or modified, or some texts may be extracted from the read text and added into the information under the corresponding feature dimension, so as to obtain the edited information.

As shown in FIG. 4, when the user edits the information in the role dimension, the user can edit in the edit box 41, for example, adding a feature of “curved eyebrows”, and the user can submit it after the editing is completed. At this time, the information obtained after editing may be determined as the target feature information, that is, the target feature information includes a feature of “curved eyebrows”.

Therefore, the user may modify and adjust on the basis of the automatically generated feature information, and the user is allowed to add, delete or change the feature information, to personalize the modification of the feature information according to his own understanding, so as to obtain the target feature information that meets his intentions, so that an image that meets his intentions can be generated subsequently. In addition, the diversity of the generated image can be improved, the satisfaction of the user on the generated image obtained subsequently can be improved, and the reading experience of the user can be improved.

As an example, the delivery content may be an incentive advertisement. When determining the displayed target delivery content, it may be randomly selected from candidate delivery contents, so that the randomness of the target delivery content can be improved, and the user is prevented from repeatedly watching the same delivery content in a short time, so as to ensure the viewing rate of the target delivery content.

As another example, the step of displaying the target delivery content when receiving, during the display process of a text, the image generation instruction associated with the delivery content may include the following steps.

Acquiring text feature information of the text when receiving, during the display process of the text, the image generation instruction associated with the delivery content.

The text feature information of the text may be brief information corresponding to the text. For example, when the text is a novel, the novel is usually associated with brief information to briefly illustrate the content of the text. In this embodiment, the text feature information may be the brief information, which may be acquired through an attribute of the text. For another example, attribute information of the text may be acquired, and analysis is performed based on a large language model and the attribute information to acquire the text feature information.

Then, the target delivery content is acquired according to the text feature information and the target delivery content is displayed.

As an example, the target delivery content is acquired from a content server, and the text feature information may be sent to the content server, so that the content server matches the candidate delivery content with the text feature information, and distributes the candidate delivery content with the highest matching degree as the target delivery content to display the target delivery content. As another example, a plurality of candidate delivery contents are stored locally, and matching may be performed based on the local candidate delivery content and the text feature information, and the candidate delivery content with the highest matching degree is displayed as the target delivery content. Therefore, through the above technical solution, the delivery content may be displayed for the user in the reading process of the user, thereby improving the viewing rate of the delivery content and the participation of the user, and providing support for subsequent effective delivery of the delivery content.

In a possible embodiment, the method may further include the following step.

Storing the generated image, the target feature information and the target text in an associated manner in response to receiving an upload operation for the generated image.

As an example, after obtaining the generated image, the user may perform sharing interaction on the image that is triggered to be generated. For example, the generated image(s) may be displayed in the interaction interface, and the user may select one or more of the generated image(s) to upload, so as to be displayed in association with the text and browsed by other users, for example, may be liked or commented by other users, so as to realize the interaction between multiple users.

For example, if the user selects the generated image P1 to upload in the interaction interface, the target text W1, the generated image P1 and the target feature information T1 may be stored in an associated manner, so that information can be acquired quickly based on the associated manner.

Each generated image associated with the target text and the target feature information of the generated image are displayed in the image display interface corresponding to the target text.

As an example, the image display interface corresponding to the target text may be displayed after all the text corresponding to the target text is displayed, that is, images uploaded by different users for the target text are displayed in the last page of the target text.

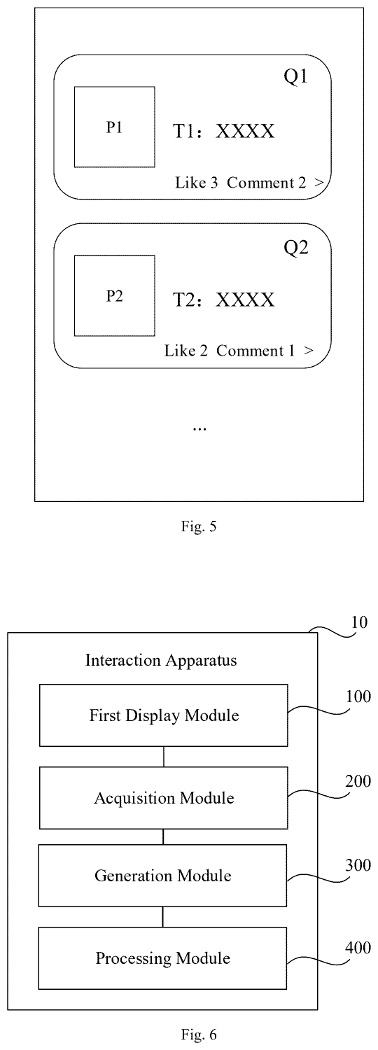

As shown in FIG. 5, for the target text W1, the user U1 uploads the image P1, and the image P1 and the target feature information T1 thereof are displayed in the region Q1; the user U2 uploads the image P2, and the image P2 and the target feature information T2 thereof are displayed in the region Q2.

Therefore, through the above technical solution, different generated images obtained for the same target text may be displayed in a unified manner, so that the multi-dimensional understanding of the user on the target object in the target text is further improved. In addition, the user's interest in image generation may also be improved, thereby providing support for increasing the traffic of the delivery content.

In a possible embodiment, the step of generating the target feature information of the target object corresponding to the target text according to the target text may include the following steps.

Candidate objects corresponding to the target text and feature information of the candidate objects are obtained based on the target text and a pre-trained text analysis model. The specific implementation of this step has been described in detail above, and will not be repeated here.

The candidate objects and the feature information of the candidate objects are displayed in the image display interface corresponding to the target text.

As described above, the image display interface may display images that have been generated by other users and the target feature information corresponding to image generation. As an example, the feature information of the candidate objects may be preferentially displayed before the images that have been generated by other users and the target feature information corresponding to image generation.

In response to receiving a selection of the user on the feature information displayed in the image display interface, the target feature information of the target object is determined according to the selected feature information.

In this embodiment, the user may select, according to his own understanding and preference, the feature information that meets his intentions from a plurality of displayed feature information. For example, the user may select the feature information of the candidate object, or may select the target feature information of the image uploaded by the user, and after confirmation by the user, the selected feature information may be used as the target feature information of the target object to perform image generation.

Therefore, through the above technical solution, the candidate objects that are currently generated and the feature information of the candidate objects and the target feature information applied by other users in image generation may be displayed for the user at the same time in the image display interface, so that a more comprehensive display is provided for the user to confirm the target feature information required for the current image generation, and sharing and interaction between different users are also facilitated.

In a possible embodiment, the step in which the generated image corresponding to the target object is generated according to the target feature information and displayed may include the following steps.

Text preprocessing is performed according to the target feature information to obtain a processed text.

As an example, the text preprocessing may be to perform spell checking, process synonyms and phrases, etc. on the target feature information, so as to keep the semantic consistency of the text in the target feature information.

Then, key information extraction is performed on the processed text to obtain key information corresponding to the processed text.

As an example, in this step, key information of the processed text may be extracted based on an NLP technology, such as gender, age, posture, expression, clothes, and other related features. The dimension of the key information may be preset based on an actual application scenario, which is not limited in the present disclosure.

Then, a target prompt text is constructed according to the key information, and the generated image is generated according to the target prompt text and a pre-trained image generation model and the generated image is displayed.

As an example, in this step, the key information may be constructed according to a prompt template to obtain the target prompt text. As another example, a semantic transformation algorithm may also be used, for example, the key information is transformed into the target prompt text through semantic analysis and semantic understanding. The key information may be transformed into structured information by constructing the target prompt text, for example, the key information may be structured into one or a series of sentences with clear semantic descriptions. For example, the target prompt text prompt may include a sentence with the same semantic as the key information, and the format of the sentence matches the input of the image generation model. For example, the target feature information is expressed as “a young lady, with a lovely smile, shiny eyes, wearing a long blue dress”, and the target prompt text obtained through the above steps is expressed as “depict a young lady with a lovely smile, shiny eyes, wearing a long blue dress”.

Then, the target prompt text may be input into the image generation model, and the output of the image model is token as the generated image and the generated image is displayed. The image generation model may be a model implemented based on a generative adversarial network, which may be trained by pre-constructing training data including prompt texts and corresponding images thereof, and the specific training manner will not be repeated here.

Further, new training data may be obtained from the images displayed in the image display interface and the target feature information thereof. For example, some images may be selected from the images displayed in the image display interface, and processing is performed based on the target feature information of the images to obtain corresponding prompt texts. Then, the image generation model may be updated based on the selected images and the corresponding prompt texts thereof, so as to further improve the accuracy of the image generation model.

Therefore, in the technical solution, the target prompt text is obtained by processing the target feature information, so that a structured description text may be provided for image generation, and the understanding accuracy of the image generation model on the target prompt text is improved, thereby improving the accuracy of the generated image.

Based on the same inventive concept, the present disclosure further provides an interaction apparatus. As shown in FIG. 6, the apparatus 10 includes:
a first display module 100, configured to play a target delivery content when receiving, during a display process of a text, an image generation instruction associated with delivery content;
an acquisition module 200, configured to acquire a target text corresponding to the image generation instruction from the text in response to determining that display of the target delivery content is completed;
a generation module 300, configured to generate target feature information of a target object corresponding to the target text according to the target text; and
a processing module 400, configured to generate a generated image corresponding to the target object according to the target feature information and display the generated image.

Optionally, the generation module includes:
a first processing sub-module, configured to obtain candidate objects corresponding to the target text and feature information of the candidate objects based on the target text and a pre-trained text analysis model;
a first determination sub-module, configured to determine a selected candidate object as the target object in response to receiving a selection operation of a user on the candidate objects; and
a first generation sub-module, configured to generate the target feature information of the target object according to feature information of the target object.

Optionally, the first generation sub-module includes:
a first display sub-module, configured to display the feature information of the target object; and
a second determination sub-module, configured to determine feature information obtained after editing as the target feature information in response to receiving an edit operation of the user on the feature information of the target object.

Optionally, the first display module includes:
a first acquisition sub-module, configured to acquire text feature information of the text when receiving, during the display process of the text, the image generation instruction associated with the delivery content; and
a second acquisition sub-module, configured to acquire the target delivery content according to the text feature information and display the target delivery content.

Optionally, the apparatus further includes:
a storage module, configured to store the generated image, the target feature information and the target text in an associated manner in response to receiving an upload operation for the generated image; and
a second display module, configured to display, in an image display interface corresponding to the target text, each generated image associated with the target text and target feature information of the each generated image.

Optionally, the generation module includes:
a first processing sub-module, configured to obtain candidate objects corresponding to the target text and feature information of the candidate objects based on the target text and a pre-trained text analysis model;
a second display sub-module, configured to display the candidate objects and the feature information of the candidate objects in the image display interface corresponding to the target text; and
a third determination sub-module, configured to determine the target feature information of the target object according to selected feature information in response to receiving a selection of the user on feature information displayed in the image display interface.

Optionally, the text includes a plurality of chapters.

The acquisition module includes:
a fourth determination sub-module, configured to determine a current chapter displayed in the text
in response to determining the display of the delivery content is completed; and
a fifth determination sub-module, configured to take text of the current chapter and text of first N chapters corresponding to the current chapter as the target text, where N is an integer greater than or equal to 0.

Optionally, the processing module includes:
a second processing sub-module, configured to perform text preprocessing according to the target feature information to obtain a processed text;
a third processing sub-module, configured to perform key information extraction on the processed text to obtain key information corresponding to the processed text; and
a fourth processing sub-module, configured to construct a target prompt text according to the key information, and generate the generated image according to the target prompt text and a pre-trained image generation model and display the generated image.

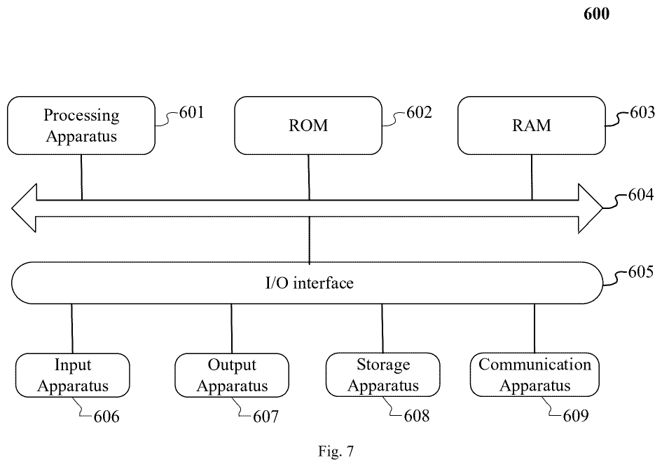

Reference is made to FIG. 7 below, which illustrates a schematic structural diagram of an electronic device 600 (such as a terminal device or a server) suitable for implementing the embodiments of the present disclosure. The terminal device in the embodiments of the present disclosure may include, but is not limited to, mobile terminals such as a mobile phone, a laptop, a digital broadcast receiver, a personal digital assistant (PDA), a tablet computer, a portable multimedia player (PMP), a vehicle-mounted terminal (such as a vehicle-mounted navigation terminal), etc., and fixed terminals such as a digital TV, a desktop computer, etc. The electronic device shown in FIG. 7 is only an example, and should not impose any limitation to the function and usage scope of the embodiments of the present disclosure.

As shown in FIG. 7, the electronic device 600 may include a processing apparatus 601 (such as a central processing unit, a graphics processing unit, etc.), which may perform various appropriate actions and processing according to a program stored in a read-only memory (ROM) 602 or a program loaded from a storage apparatus 608 into a random access memory (RAM) 603. The RAM 603 also stores various programs and data required for the operation of the electronic device 600. The processing apparatus 601, the ROM 602, and the RAM 603 are connected to each other through a bus 604. An input/output (I/O) interface 605 is also connected to the bus 604.

Generally, the following apparatuses may be connected to the I/O interface 605: an input apparatus 606, including, for example, a touchscreen, a touchpad, a keyboard, a mouse, a camera, a microphone, an accelerometer, a gyroscope, etc.; an output apparatus 607, including, for example, a liquid crystal display (LCD), a speaker, a vibrator, etc.; a storage apparatus 608, including, for example, a magnetic tape, a hard disk, etc.; and a communication apparatus 609. The communication apparatus 609 may allow the electronic device 600 to perform wireless or wired communication with other devices to exchange data. Although FIG. 7 shows the electronic device 600 having various apparatuses, it should be understood that not all of the illustrated apparatuses are required to be implemented or provided. Alternatively, more or fewer apparatuses may be implemented or provided.

Particularly, according to the embodiments of the present disclosure, the processes described above with reference to the flowcharts may be implemented as a computer software program. For example, an embodiment of the present disclosure includes a computer program product, which includes a computer program carried on a non-transitory computer-readable medium. The computer program includes program codes for executing the method shown in the flowchart. In such an embodiment, the computer program may be downloaded and installed from a network through the communication apparatus 609, or may be installed from the storage apparatus 608, or may be installed from the ROM 602. When the computer program is executed by the processing apparatus 601, the above functions defined in the method of the embodiments of the present disclosure are executed.

It should be noted that the above computer-readable medium in the present disclosure may be a computer-readable signal medium or a computer-readable storage medium, or any combination thereof. The computer-readable storage medium may be, for example, but not limited to, an electrical, magnetic, optical, electromagnetic, infrared, or semiconductor system, apparatus, or device, or any combination thereof. More specific examples of the computer-readable storage medium may include, but are not limited to, an electrical connection with one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof. In the present disclosure, the computer-readable storage medium may be any tangible medium that contains or stores a program that may be used by or in combination with an instruction execution system, apparatus, or device. In the present disclosure, the computer-readable signal medium may include a data signal propagated in a baseband or as a part of a carrier wave, and computer-readable program codes are carried in the data signal. The data signal propagated in this manner may take a variety of forms, including but not limited to an electromagnetic signal, an optical signal, or any suitable combination thereof. The computer-readable signal medium may also be any computer-readable medium other than the computer-readable storage medium. The computer-readable signal medium may send, propagate, or transmit a program used by or in combination with an instruction execution system, apparatus, or device. The program codes included on the computer-readable medium may be transmitted by any suitable medium, including but not limited to a wire, an optical cable, a radio frequency (RF), etc., or any suitable combination thereof.

In some implementations, the client and the server may communicate using any currently known or future developed network protocol such as a hypertext transfer protocol (HTTP), and may be interconnected with any form or medium of digital data communication (for example, a communication network). Examples of the communication network include a local area network (“LAN”), a wide area network (“WAN”), an internetwork (for example, the Internet), a peer-to-peer network (for example, an ad hoc network), and any currently known or future developed network.

The above computer-readable medium may be included in the above electronic device; or may exist alone without being assembled into the electronic device.

The above computer-readable medium carries one or more programs, and when the above one or more programs are executed by the electronic device, the electronic device is caused to: display a target delivery content when receiving, during a display process of a text, an image generation instruction associated with delivery content; acquire a target text corresponding to the image generation instruction from the text in response to determining that display of the target delivery content is completed; generate target feature information of a target object corresponding to the target text according to the target text; and generate a generated image corresponding to the target object according to the target feature information and displaying the generated image.

The computer program codes for executing the operations of the present disclosure may be written in one or more programming languages or a combination thereof, where the above programming languages include object-oriented programming languages such as Java, Smalltalk, C++, and also include conventional procedural programming languages such as the “C” programming language or similar programming languages. The program codes may be executed entirely on a user computer, partly on a user computer, as a stand-alone software package, partly on a user computer and partly on a remote computer, or entirely on a remote computer or a server. In the case of involving the remote computer, the remote computer may be connected to the user computer through any type of network, including a local area network (LAN) or a wide area network (WAN), or the connection may be made to an external computer (for example, through the Internet using an Internet service provider).

The flowcharts and block diagrams in the drawings illustrate the architecture, functionality, and operation of possible implementations of systems, methods, and computer program products according to various embodiments of the present disclosure. In this regard, each block in the flowcharts or block diagrams may represent a module, a program segment, or a part of codes, and the module, the program segment, or the part of codes contains one or more executable instructions for implementing specified logical functions. It should also be noted that, in some alternative implementations, the functions noted in the blocks may also occur in an order different from that noted in the drawings. For example, two blocks shown in succession may, in fact, be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules involved in the embodiments of the present disclosure may be implemented in software or hardware. The name of a module does not constitute a limitation on the module itself under certain circumstances, for example, the first display module may also be described as “a module for displaying the target delivery content when receiving, during a display process of a text, the image generation instruction associated with the delivery content”.

The functions described herein above may be performed, at least in part, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof.

According to one or more embodiments of the present disclosure, Example 1 provides an interaction method, where the method includes:
displaying a target delivery content when receiving, during a display process of a text, an image generation instruction associated with delivery content;
acquiring a target text corresponding to the image generation instruction from the text in response to determining that display of the target delivery content is completed;
generating target feature information of a target object corresponding to the target text according to the target text; and
generating a generated image corresponding to the target object according to the target feature information and displaying the generated image.

According to one or more embodiments of the present disclosure, Example 2 provides the method of Example 1, where generating the target feature information of the target object corresponding to the target text according to the target text includes:
obtaining candidate objects corresponding to the target text and feature information of the candidate objects based on the target text and a pre-trained text analysis model;
determining a selected candidate object as the target object in response to receiving a selection operation of a user on the candidate objects; and
generating the target feature information of the target object according to feature information of the target object.

According to one or more embodiments of the present disclosure, Example 3 provides the method of Example 2, where generating the target feature information of the target object according to the feature information of the target object includes:
displaying the feature information of the target object; and
determining feature information obtained after editing as the target feature information in response to receiving an edit operation of the user on the feature information of the target object.

According to one or more embodiments of the present disclosure, Example 4 provides the method of Example 1, where displaying the target delivery content when receiving, during the display process of a text, the image generation instruction associated with the delivery content includes:
acquiring text feature information of the text when receiving, during the display process of the text, the image generation instruction associated with the delivery content; and
acquiring the target delivery content according to the text feature information and displaying the target delivery content.

According to one or more embodiments of the present disclosure, Example 5 provides the method of Example 1, where the method further includes:
storing the generated image, the target feature information and the target text in an associated manner in response to receiving an upload operation for the generated image; and
displaying, in an image display interface corresponding to the target text, each generated image associated with the target text and target feature information of the each generated image.

According to one or more embodiments of the present disclosure, Example 6 provides the method of Example 5, where generating the target feature information of the target object corresponding to the target text according to the target text includes:
obtaining candidate objects corresponding to the target text and feature information of the candidate objects based on the target text and a pre-trained text analysis model;
displaying the candidate objects and the feature information of the candidate objects in the image display interface corresponding to the target text; and
determining the target feature information of the target object according to selected feature information in response to receiving a selection of the user on feature information displayed in the image display interface.

According to one or more embodiments of the present disclosure, Example 7 provides the method of Example 1, where the text includes a plurality of chapters.

The step of acquiring the target text corresponding to the image generation instruction from the text in response to determining the display of the target delivery content is completed includes:
determining a current chapter displayed in the text in response to determining the display of the delivery content is completed; and
taking text of the current chapter and text of first N chapters corresponding to the current chapter as the target text, where N is an integer greater than or equal to 0.

According to one or more embodiments of the present disclosure, Example 8 provides the method of Example 1, where generating the generated image corresponding to the target object according to the target feature information and displaying the generated image includes:
performing text preprocessing according to the target feature information to obtain a processed text;
performing key information extraction on the processed text to obtain key information corresponding to the processed text; and
constructing a target prompt text according to the key information, and generating the generated image according to the target prompt text and a pre-trained image generation model and displaying the generated image.

According to one or more embodiments of the present disclosure, Example 9 provides an interaction apparatus, the apparatus including:
a first display module, configured to display a target delivery content when receiving, during a display process of a text, an image generation instruction associated with delivery content;
an acquisition module, configured to acquire a target text corresponding to the image generation instruction from the text in response to determining that display of the target delivery content is completed;
a generation module, configured to generate target feature information of a target object corresponding to the target text according to the target text; and
a processing module, configured to generate a generated image corresponding to the target object according to the target feature information and display the generated image.

According to one or more embodiments of the present disclosure, Example 10 provides a computer-readable medium, on which a computer program is stored, where the computer program, when executed by a processing apparatus, implements the steps of the method according to any one of Examples 1-8.

According to one or more embodiments of the present disclosure, Example 11 provides an electronic device, including:
a storage apparatus, on which a computer program is stored; and
a processing apparatus, configured to execute the computer program in the storage apparatus to implement the steps of the method according to any one of Examples 1-8.

According to one or more embodiments of the present disclosure, Example 12 provides a computer program product, including a computer program, where the computer program, when executed by a processor, implements the steps of the method according to any one of Examples 1-8.

The above description is only preferred embodiments of the present disclosure and an illustration of the applied technical principles. Those skilled in the art should understand that the scope of disclosure involved in the present disclosure is not limited to the technical solution formed by a specific combination of the above technical features, and should also cover other technical solutions formed by any combination of the above technical features or equivalent features thereof without departing from the above disclosed concept, for example, a technical solution formed by replacing the above features with technical features with similar functions disclosed in the present disclosure (but not limited to).

In addition, although various operations are depicted in a specific order, this should not be understood as requiring these operations to be performed in the specific order shown or in a sequential order. Under certain circumstances, multitasking and parallel processing may be advantageous. Likewise, although the above discussion contains several specific implementation details, these should not be construed as limiting the scope of the present disclosure. Certain features that are described in the context of separate embodiments may also be implemented in combination in a single embodiment. Conversely, various features that are described in the context of a single embodiment may also be implemented in multiple embodiments individually or in any suitable sub-combination.

Although the subject matter has been described in language specific to structural features and/or logical actions of the method, it should be understood that the subject matter defined in the appended claims is not necessarily limited to the specific features or actions described above. Rather, the specific features and actions described above are only example forms of implementing the claims. Regarding the apparatus in the above embodiments, the specific manner in which each module performs operations has been described in detail in the embodiments related to the method, and will not be described in detail here.

1. An interaction method, comprising:
displaying a target delivery content in response to receiving, during a display process of a text, an image generation instruction associated with delivery content;
acquiring a target text corresponding to the image generation instruction from the text in response to determining that display of the target delivery content is completed;
generating target feature information of a target object corresponding to the target text according to the target text; and
generating a generated image corresponding to the target object according to the target feature information and displaying the generated image.

2. The method according to claim 1, wherein generating the target feature information of the target object corresponding to the target text according to the target text comprises:
obtaining candidate objects corresponding to the target text and feature information of the candidate objects based on the target text and a pre-trained text analysis model;
determining a selected candidate object as the target object in response to receiving a selection operation of a user on the candidate objects; and
generating the target feature information of the target object according to feature information of the target object.

3. The method according to claim 2, wherein generating the target feature information of the target object according to the feature information of the target object comprises:
displaying the feature information of the target object; and
determining feature information obtained after editing as the target feature information in response to receiving an edit operation of the user on the feature information of the target object.

4. The method according to claim 1, wherein displaying the target delivery content in response to receiving, during the display process of a text, the image generation instruction associated with the delivery content comprises:
acquiring text feature information of the text in response to receiving, during the display process of the text, the image generation instruction associated with the delivery content; and
acquiring the target delivery content according to the text feature information and displaying the target delivery content.

5. The method according to claim 1, further comprising:
storing the generated image, the target feature information and the target text in an associated manner in response to receiving an upload operation for the generated image; and
displaying, in an image display interface corresponding to the target text, each generated image associated with the target text and target feature information of the each generated image.

6. The method according to claim 5, wherein generating the target feature information of the target object corresponding to the target text according to the target text comprises:
obtaining candidate objects corresponding to the target text and feature information of the candidate objects based on the target text and a pre-trained text analysis model;
displaying the candidate objects and the feature information of the candidate objects in the image display interface corresponding to the target text; and
determining the target feature information of the target object according to selected feature information in response to receiving a selection of the user on feature information displayed in the image display interface.

7. The method according to claim 1, wherein the text comprises a plurality of chapters; and
acquiring the target text corresponding to the image generation instruction from the text in response to determining that the display of the target delivery content is completed comprises:
determining that a current chapter displayed in the text in response to determining the display of the delivery content is completed; and
taking text of the current chapter and text of first N chapters corresponding to the current chapter as the target text, wherein N is an integer greater than or equal to 0.

8. The method according to claim 1, wherein generating the generated image corresponding to the target object according to the target feature information and displaying the generated image comprises:
performing text preprocessing according to the target feature information to obtain a processed text;
performing key information extraction on the processed text to obtain key information corresponding to the processed text; and
constructing a target prompt text according to the key information, and generating the generated image according to the target prompt text and a pre-trained image generation model and displaying the generated image.

9. An electronic device, comprising:
at least a processor, and
a non-transitory memory with instructions thereon,
wherein the instructions upon execution by the processor, cause the processor to:
display a target delivery content in response to receiving, during a display process of a text, an image generation instruction associated with delivery content;
acquire a target text corresponding to the image generation instruction from the text in response to determine that display of the target delivery content is completed;
generate target feature information of a target object corresponding to the target text according to the target text; and
generate a generated image corresponding to the target object according to the target feature information and display the generated image.

10. The electronic device according to claim 9, wherein when generating the target feature information of the target object corresponding to the target text according to the target text, the processor is caused to:
obtain candidate objects corresponding to the target text and feature information of the candidate objects based on the target text and a pre-trained text analysis model;
determine a selected candidate object as the target object in response to receiving a selection operation of a user on the candidate objects; and
generate the target feature information of the target object according to feature information of the target object.

11. The electronic device according to claim 10, wherein when generating the target feature information of the target object according to the feature information of the target object, the processor is caused to:
display the feature information of the target object; and
determine feature information obtained after editing as the target feature information in response to receiving an edit operation of the user on the feature information of the target object.

12. The electronic device according to claim 9, wherein when displaying the target delivery content in response to receiving, during the display process of a text, the image generation instruction associated with the delivery content, the processor is caused to:
acquire text feature information of the text in response to receiving, during the display process of the text, the image generation instruction associated with the delivery content; and
acquire the target delivery content according to the text feature information and displaying the target delivery content.

13. The electronic device according to claim 9, wherein the processor is further caused to:
store the generated image, the target feature information and the target text in an associated manner in response to receiving an upload operation for the generated image; and
display, in an image display interface corresponding to the target text, each generated image associated with the target text and target feature information of the each generated image.

14. The electronic device according to claim 13, wherein when generating the target feature information of the target object corresponding to the target text according to the target text, the processor is caused to:
obtain candidate objects corresponding to the target text and feature information of the candidate objects based on the target text and a pre-trained text analysis model;
display the candidate objects and the feature information of the candidate objects in the image display interface corresponding to the target text; and
determine the target feature information of the target object according to selected feature information in response to receiving a selection of the user on feature information displayed in the image display interface.

15. The electronic device according to claim 9, wherein the text comprises a plurality of chapters; and
when acquiring the target text corresponding to the image generation instruction from the text in response to determining the display of the target delivery content is completed, the processor is caused to:
determine a current chapter displayed in the text in response to determining the display of the delivery content is completed; and
take text of the current chapter and text of first N chapters corresponding to the current chapter as the target text, wherein N is an integer greater than or equal to 0.

16. The electronic device according to claim 9, wherein when generating the generated image corresponding to the target object according to the target feature information and displaying the generated image, the processor is caused to:
perform text preprocessing according to the target feature information to obtain a processed text;
perform key information extraction on the processed text to obtain key information corresponding to the processed text; and
construct a target prompt text according to the key information, and generating the generated image according to the target prompt text and a pre-trained image generation model and display the generated image.

17. A non-transitory computer-readable storage medium storing instructions that cause at least a processor to
display a target delivery content in response to receiving, during a display process of a text, an image generation instruction associated with delivery content;
acquire a target text corresponding to the image generation instruction from the text in response to determine that display of the target delivery content is completed;
generate target feature information of a target object corresponding to the target text according to the target text; and
generate a generated image corresponding to the target object according to the target feature information and display the generated image.

18. The non-transitory computer-readable storage medium according to claim 17, wherein when generating the target feature information of the target object corresponding to the target text according to the target text, the processor is caused to:
obtain candidate objects corresponding to the target text and feature information of the candidate objects based on the target text and a pre-trained text analysis model;
determine a selected candidate object as the target object in response to receiving a selection operation of a user on the candidate objects; and
generate the target feature information of the target object according to feature information of the target object.

19. The non-transitory computer-readable storage medium according to claim 17, wherein when displaying the target delivery content in response to receiving, during the display process of a text, the image generation instruction associated with the delivery content, the processor is caused to:
acquire text feature information of the text in response to receiving, during the display process of the text, the image generation instruction associated with the delivery content; and
acquire the target delivery content according to the text feature information and displaying the target delivery content.

20. The non-transitory computer-readable storage medium according to claim 17, wherein the processor is further caused to:
store the generated image, the target feature information and the target text in an associated manner in response to receiving an upload operation for the generated image; and
display, in an image display interface corresponding to the target text, each generated image associated with the target text and target feature information of the each generated image.
